(19) United States
(12) Patent Application Publication
(10) Pub. No.: US 2006/0054572 A1
(43) Pub. Date: Mar. 16, 2006

(54) Processing samples of liquid material

(76) Inventors: Peter Ivan Sygall, Riethoven (NL); Klaus Weber-Mathiessen, Achterwehr (DE)

Correspondence Address: QUARLES & BRADY LLP, 411 E. WISCONSIN AVENUE, SUITE 2040, MILWAUKEE, WI, 53202-4497, US

(21) Appl. No.: 10/513,499

(22) PCT Filed: May 6, 2002
(86) PCT No.: PCT/EP02/05086

§ 371 Date: Jul. 13, 2005

(51) Int. Cl. C02F 1/38

(52) U.S. Cl. 210/787; 210/512.1; 436/177; 422/63; 422/101

(57) ABSTRACT

Liquid samples containing for example differerent combinations of DNA and markers are subjected to various processing steps, for examle exposure to different temperature baths. A flexible band is used that contains a series of cavities arranged along a longitudinal direction of the flexible band. The liquid samples are inserted into the cavities and the band is subsequently fed through a succession of processing stations. The band extends through the stations when the processing steps of the stations are applied. By advancing the band the samples are subjected to successive processing stages. At the end of the process the band may be disposed of, for eexample after extracting the samples.

The invention relates to apparatuses and methods for processing samples of liquid material.

In modern biochemical applications it is desirable to process vast numbers of samples of chemical substances. Present day procedures call for processing of hundreds of thousands of samples per day and this number will increase to millions of samples per day in the foreseeable future. Processing involves such operations as preparing mixtures by mixing different combinations of liquids, isolating samples from liquids and subjecting the samples to other processing steps such as temperature cycling.

The vast number samples call for massive automation of processing. At present this is realized by using trays comprising a rectangular grid of cavities, each for a respective one of the samples. During processing the samples are inserted in the cavities, the trays are sealed with a plastic foil that covers the cavities and the trays are subjected as a whole to successive further processing steps. The trays make it possible to process large numbers of samples as a batch. Nevertheless processing at the vast scale that is needed still presents problems and considerable costs.

Amongst others it is an object of the invention to provide for apparatuses and methods for more efficient processing samples of liquid at a vast scale.

An apparatus according to the invention is set forth in claim 1. The apparatus uses a flexible band, such as a tape, with a sequence of cavities for transporting the liquid samples. The band is wound through various processing stages to an end stage. Thus, an efficient continuous process is realized, in which the treatment of the samples in the cavities is realized collectively by transport of the band.

The band is supplied externally, for example from a spool and extends through a plurality of processing stages. Preferably the the cavities are sealed. In this case the may be wound through the processing stages so that the cavities do not remain horizontal during all of the process: the cavities may be oriented sideways or upside down during part of the track.

At the end of processing the band is disposed of, for example by extracting the samples one after the other (or in successive groups) from the cavities as the band passes by and subsequently shredding the part of the band from which samples have been extracted. Alternatively the band may be spooled onto a reception spool for disposal, or the band may be cut to pieces that still contain samples for batchwise processing.

Preferably, the cavities are integral parts of the band. This makes it very economical to manufacture the band; for example by head forming the cavities from an originally flat band.

In an embodiment the cavities are sealed by placing caps into the cavities. Thus, the samples in the cavities are protected from external influences. Preferably, the caps are supplied in the band, adjacent the cavities. Thus no separate transport for caps is needed. Preferably the caps are integral parts of the band initially, the caps being at least partly cut out of the band in order to place them in the cavities. This lowers the manufacturing cost.

In another embodiment, caps and cavities have a conically shaped surface part, so that the surface parts of cap and cavity fit together when the caps are inserted into the cavities. The liquid sample in each cavity is contained in a space left between the bottom of the cavity and the cap, a tight seal being realized with the contacting surface parts.

When both caps and cavities are included in the band, caps and cavities preferably extend substantially equal distances from the surface of the band. Thus the band can easily be wound on a supply spool. To provide caps with a size that leaves space for the sample but do not extend well beyond the surface of the band when inserted into the cavities, the caps are preferably provided in indentations of the band with a cutting surface that is offset from the surface of the band from which the caps are cut out to insert them into the cavities.

Preferably, the size of the space for the sample and the amount of liquid in each sample are substantially adapted to each other, so that no air is left in said space when the cap is placed in the cavity. Preferably the cavity contains an overflow space for trapping liquid pushed out by the cap beyond the fitting conically shaped surface parts. The overflow space is a region where the cavity is wider than the cap, when inserted. Thus, uncontrolled dispersal of liquid may be prevented by trapping liquid overflowing from the enclosed space for the sample in the overflow space. The cap may be used also to push out any air from the space for the sample.

Preferably, caps and cavities extend from flanges and the caps are additionally sealed by joining flanges from the cap and the cavity, for example by heat sealing. Thus a secure double seal is realized. In the embodiment where there is an overflow space between cap and cavity the seal with the flange preferably closes off the overflow space, trapping the overflow of liquid, so that is cannot spill.

Preferably the duration of various processing steps relative to each other is adjusted by means of the length of the section of the transport path for the band that runs through the respective stations for applying the processing steps. In an embodiment the transport path is in at least one of the processing station is folded, with an adjustable return position, so that the length of the path through the station can be adjusted without varying the size of the station.

In another embodiment the path of the band over which the band extends continuously may pass through a first processing station twice, before and after the path passes through a second station. Thus the first station can be used to perform several processing steps at different sequential stages in a series of successive processing steps at the same time.

The band may be cut into pieces containing one or more cavities after passing through the processing stations for further processing, such as chemical analysis. The cavities are arranged along the length of the band, but in addition they may also be arranged in rows transverse to the length of the band. Thus a wider band can be used to provide a higher throughput.

These and other objects and advantageous aspects of the apparatus and method according to the invention will be described in more detail using the following figures.

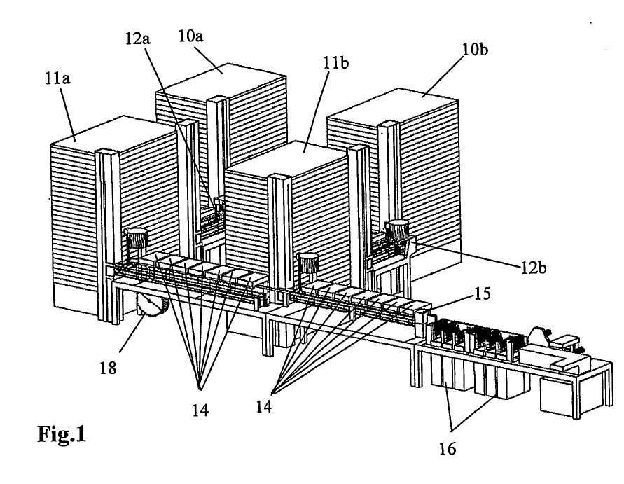

FIG. 1 shows an overview of a system for processing liquid samples

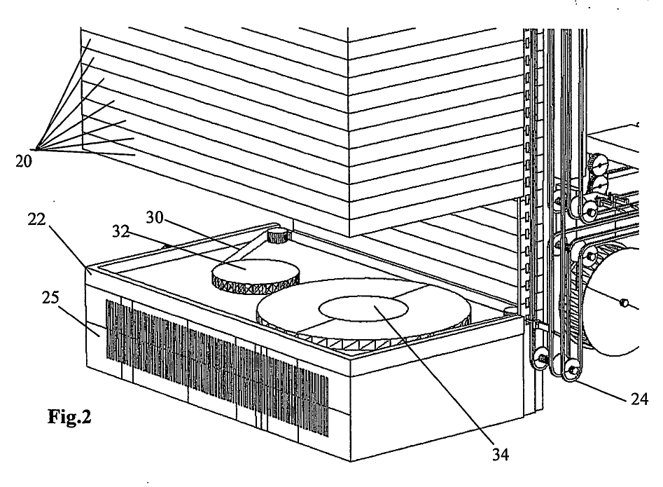

FIG. 2 shows a liquid container storage device

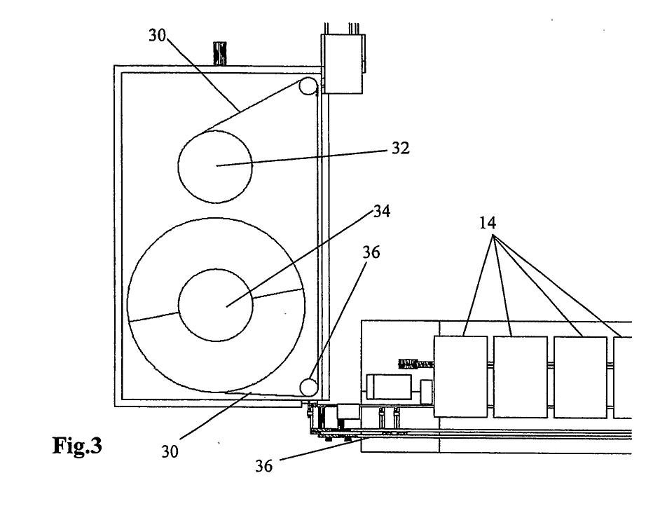

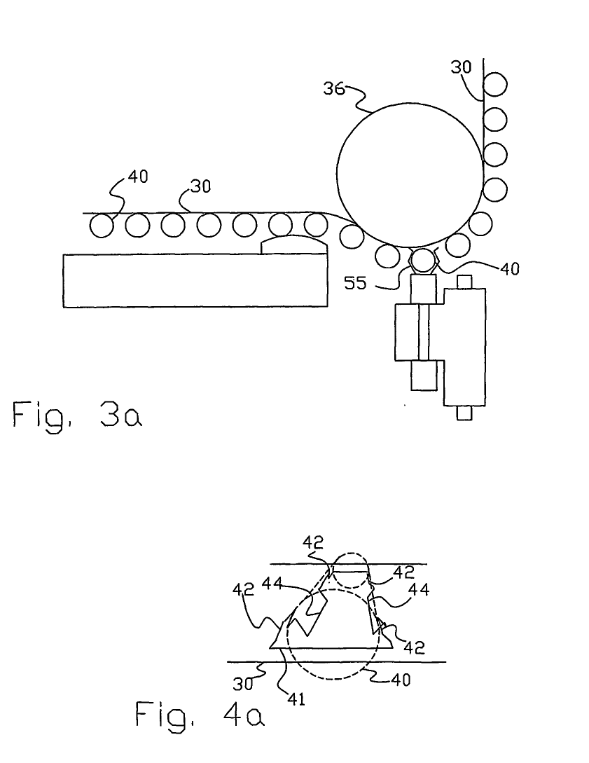

FIG. 3 shows a unit for use in a storage device

FIG. 3a shows a detail of a unit for use in a storage device

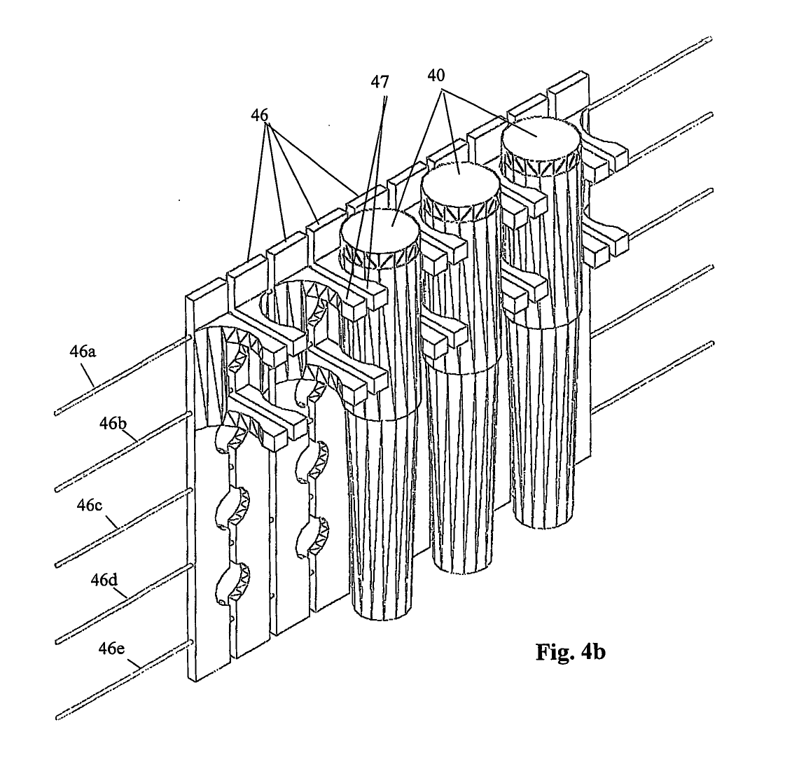

FIG. 4a shows part of a band with attachment points for liquid containers

FIG. 4b shows another embodiment of part of a band

FIG. 5 shows a transport chain for transporting liquid containers

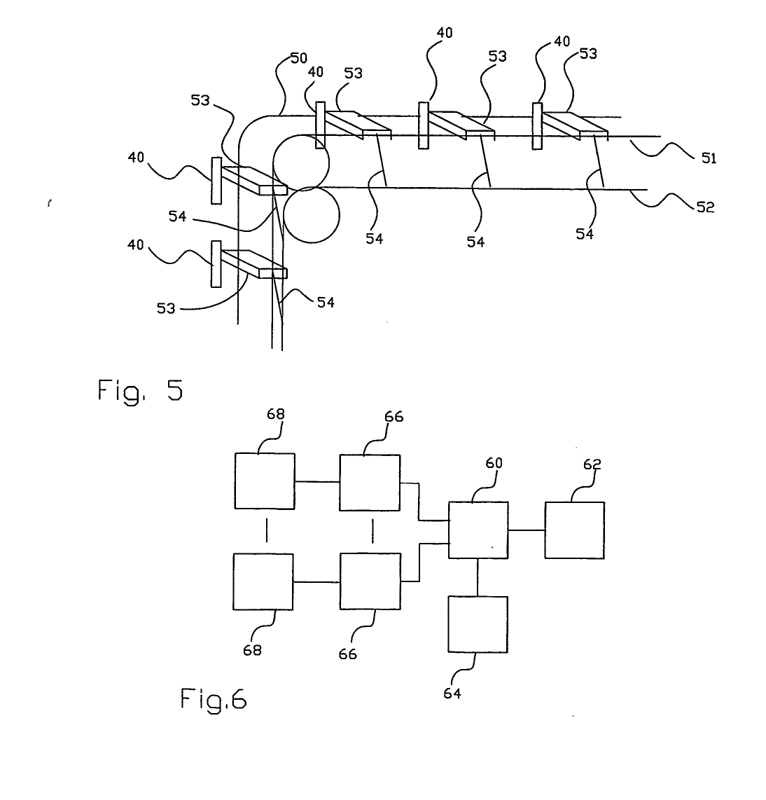

FIG. 6 shows a control system

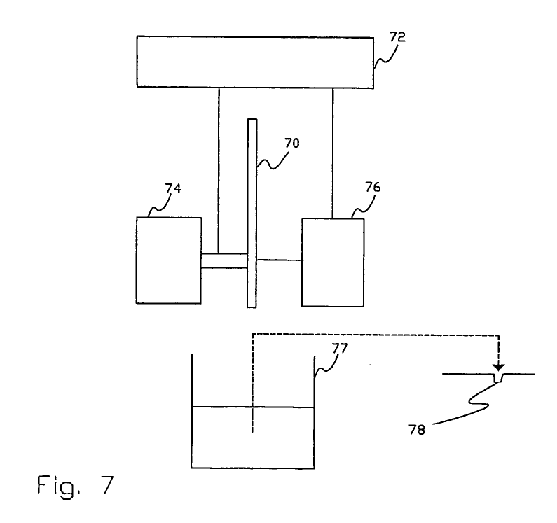

FIG. 7 shows part of a sample forming machine

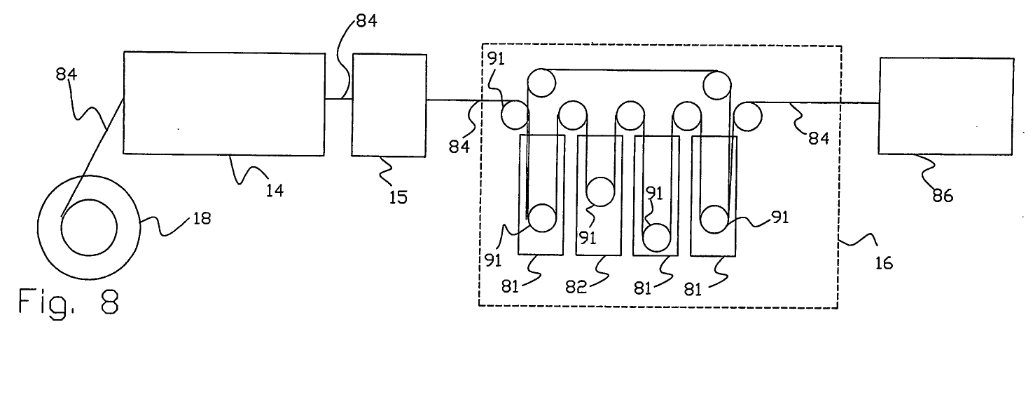

FIG. 8 an apparatus for processing samples

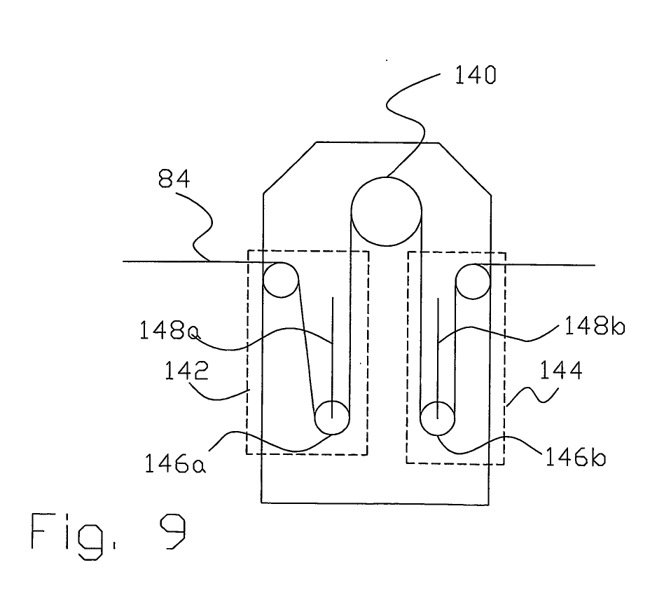

FIG. 9 shows part of an extraction station

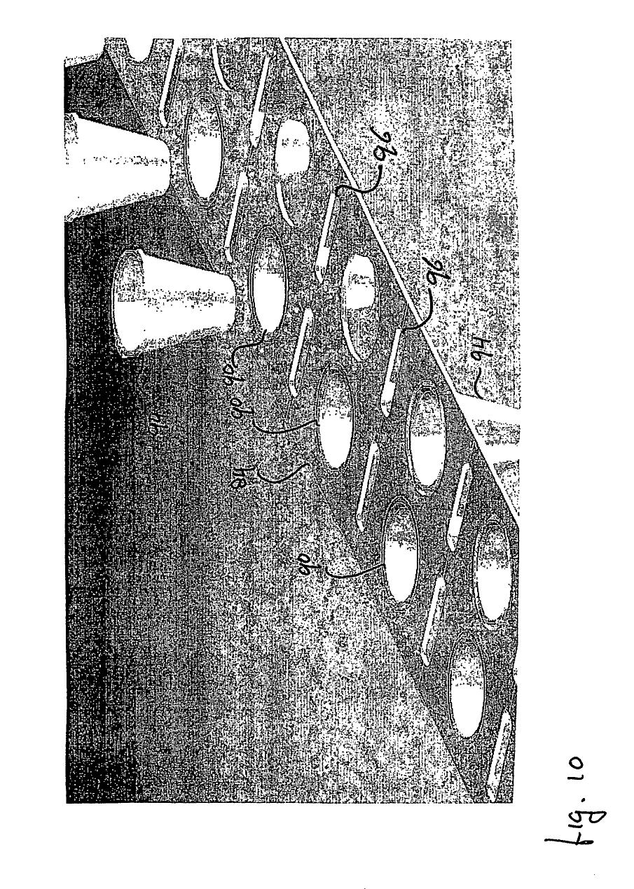

FIG. 10 shows a band for transporting samples

FIG. 11 shows a cross-section of a band prior to sealing

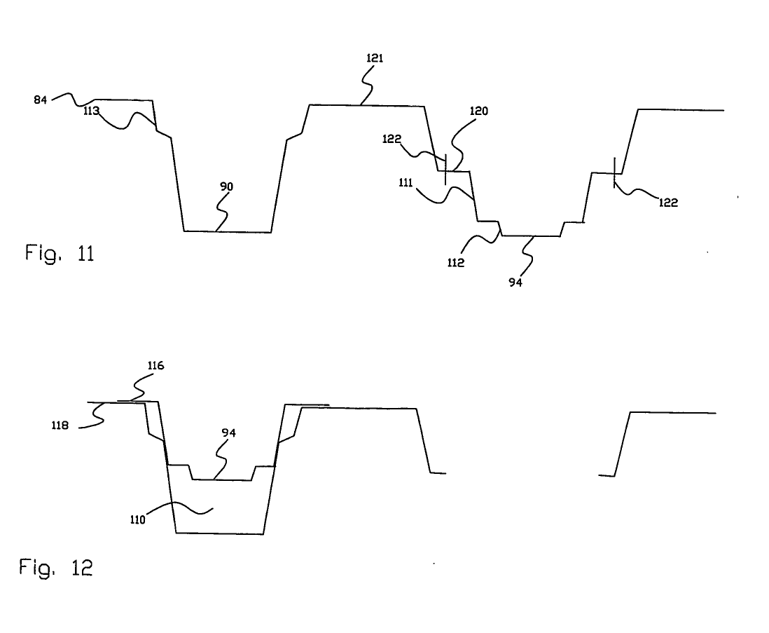

FIG. 12 shows a band after sealing

FIG. 1 shows an overview of a system for processing liquid samples. The system contains a plurality of storage devices 10a-b, 11a-b, first mixing apparatuses 12a-b between pairs of storage devices 10a-b, 11a-b, a spool 18, sample forming apparatuses 14, a sealing unit 15 and a collective sample processing apparatus 16.

In operation storage devices 10a-b, 11a-b store large numbers liquid containers (not shown) for example around 100,000 liquid containers in each storage device 10a-d, 11a-b. The liquid containers are for example liquid filled tubes with a diameter of approximately one centimetre and a length of approximately four centimetres. In one example, a first one of the storage devices 10a contains liquid containers with concentrated DNA material, a second one of the storage devices 10b contains liquid containers with concentrated markers, a third one of the storage devices 11a contains liquid containers with diluted DNA and a fourth one of the storage devices 11b contains liquid containers with diluted markers.

Although only two storage devices 10a-b are shown by way of example any number of storage devices 10a-b (one or more) may be used in the system, as separate sources for liquids that must be mixed together, or as alternative sources for such liquids. Additionally some additional supply may be provided for some generally used liquids, such as water.

The containers are extracted selectively from the storage devices 10a-b and transported to mixing apparatus 12a-b. In mixing each apparatus 12a-b liquid is extracted from different containers and mixed with buffer fluid in output containers (not shown) to provide output containers with diluted liquid (DNA or markers for example). Generally, there is a limited number of different buffer liquids (compared with the number of containers), available in larger containers in the mixing apparatus 12a-b and each of the buffer liquids or combinations thereof may be used to dilute the liquid material from the first and the second one of the storage devices 10a-b.

The liquid containers with diluted fluid are output from the mixing apparatuses 12a-b and inserted into the third and fourth one of the storage devices 11a-b. The original liquid containers are reinserted into the first and second one of the storage devices 10a-b.

The liquid containers with diluted liquid are extracted selectively from the storage devices 10a-b and transported to sample forming apparatus 14 Sample forming apparatus 14 isolates small samples from the diluted liquid in the extracted liquid containers and inserts these samples into cavities (not shown) in a band with cavities that is fed from spool 18 along sample forming apparatus 14, via sealing unit 15 to sample processing apparatusses 16. Each cavity receives samples from containers from both the third and fourth one of the storage devices 11a-b and possibly additional diluting liquid. Sealing unit 15 seals the cavities. From sealing unit 15 the cavities are transported to collective sample processing apparatus 16 which processes the samples collectively. The samples that have undergone processing may be subjected to further processing in further apparatuses (not shown).

Storage Device

The storage device is designed to store a large number of liquid containers in a compact space in such a way that the containers can be extracted from the storage device and reinserted into the storage device at a high throughput rate. In many cases storage at low temperatures is required, involving forced cooling of the liquid containers. In this case the access mechanism to the liquid containers has to have a low operating temperature range.

FIG. 2 shows part of a storage device for use in the system of FIG. 1. The storage device contains a stack of identical units 20, 22 and a transport chain 24. The path of the transport chain has a stretch that runs in the stacking direction of units 20, 22, crossing successive ones of the units at corresponding positions in the units 20, 22. By way of example forty units 20, 22 may be stacked in the stack. To show one of the units 22 in more detail some of the units in the stack that obstruct the view at this one of the units 22 have been omitted from the figure. When cooled storage is required, the storage device may also include a cooling unit 25 for cooling the units 20, 22.

FIG. 3 shows unit 22 in top view. The unit 22 contains a band 30, with a portion of the band exposed and remainders of the band on either side of the exposed portion wound around two rotatable axes 32, 34 respectively. Unit 22 contains a bending element 36 that is positioned against the exposed portion of the band 30. Transport chain 24 runs transverse to the longitudinal direction of band 30 a location where bending element 36 bends band 30.

FIG. 3a shows a detail of unit 22 in top view, with band 30, liquid containers 40, bending element 36 and a gripper 55 from transport chain 24.

FIG. 4a shows part of a first embodiment of band 30, with a liquid container 40 detachably attached to the band 30. The band 30 provides a series of attachment points at successive positions along the longitudinal direction of the band 30. In the example of FIG. 4, each attachment point is realized by a rectangular substantially cut out portion in band 30, with springs 42 formed from part of the material in the cut out portion and bent to hold containers 40. By way of example, each attachment position is shown to contain springs 42 on one side of band 30 inclined over the cut out portion and a bent portion 44 on the other side of band 30 in the cut out portion, but without deviating from the invention other configurations may be used, such as springs inclined over the cut out portion on both sides of the band. In each case, the springs hold container 40 in the cut out portion.

FIG. 4b shows an another embodiment of band 30. In this embodiment band 30 contains a plurality of wires 46a-e tow which holding elements 47 have been attached. Protrusions 48 extend from holding elements 47. Protrusions 48 have a surface part that fits around part of the surface of containers 40, so that containers 40 are securely held between protrusions of different holding elements 47 when band 30 is not bent or bent by less than a predetermined radius of curvature.

FIG. 5 schematically shows an embodiment of part of the transport chain 24. Transport chain 24 contains first, second and third sub-chains 50, 51, 52. A holder 53 is mounted on a rotatable axis that has opposite ends extending into a first and second sub-chain 50, 51. A link 54 is coupled to holder 53 with a fixed joint and to third sub-chain 52 with a rotatable joint. Each holder 53 contains a movable gripper (not shown) with fingers (not shown) capable of holding a liquid container 40. The sub-chains 50, 51, 52 are endless chains, that run substantially in parallel with each other. At points where the path of the sub-chains 50, 51, 53 bends, the path of third sub-chain 52 differs from that of first and second sub-chains 50, 51 so that the joints in third sub-chain 52 run in advance or backward of second sub-chain 51 over such a distance with respect to second sub-chain 51 that link 54 retains the same orientation over the entire path of the sub-chains 50, 51, 52, thereby keeping holder 53 at a constant orientation so that containers 40 are always kept vertical.

FIG. 6 shows a control system for controlling the storage device. The control system contains a processing unit 60, a memory 62, a liquid selection input interface 64 and rotation control outputs 66. The rotation control outputs 66 are coupled to motor units 68 which are coupled each to the axes 32, 34 of a respective one of the units 20, 22.

In operation, the storage device allows individual containers 40 to be attached to the bands 30 in the various units 20, 22 and to be detached from these bands. Each band 30 is spooled from one axis 32, 34 to the other in order to position an attachment point, from which the container 40 is detached and/or to which the container 40 has to be attached, into an attachment or deattachment position (which are preferably the same) relative to transport chain 24. At this position the container 40 is transferred between band 30 and transport chain 24. Transport chain 24 transports the containers 40 between the attachment and/or deattachment points and processing locations, which are generally outside the storage device.

Thus, the portions of band 30 that are wound around the axes 32, 34 provide a compact storage for a large number of containers, for example 6000 containers per unit 20, 22. At the same time rapid access for attachment or deattachment of the containers 40 to band 30 is ensured by spooling. In an example, less than 10 seconds is needed to spool the band to a position where a selected attachment point is positioned near transport chain 24.

In more detail, in order to deattach containers the control system receives selection signals selecting liquids (and more particularly containers that contain these liquids) that have to be taken from the bands 30 in units 20, 22. The control system keeps a information about the positions where the containers are attached to the bands 30 in units 20, 22. This may be realized for example with a data base with records of the type

(container identification, unit identification, attachment point identification)

When the control system receives a selection signal for a container, processing unit 60 consults memory 62 to determine the attachment point and, if necessary, the unit 20, 22 where the requested container is attached to a band in the units 20, 22. Thereupon, processing unit 60 sends a signal to rotation control outputs 66 to drive motor units 68 so as to rotate the axes 32, 34 of the unit 20, 22 that holds the requested container, so that the attachment point at which the container is attached to the band is moved to the deattachment position.

At the deattachment position bending element 36 forces band 30 to bend, increasing the radius of curvature of band 30 to such an extent that springs 42 release the container 40, or at least substantially reduce a holding force exerted by springs 42, allowing grippers 55 to take the container 40 from band 30. The gripper is pushed forward so that the tips of resilient fingers 56 move past the container, allowing fingers 56 to grip the container. Fingers 56 are moved towars each other so as to grip the container 40. Gripper 55 is then pulled back, taking the container with it so that the container is deattached from band 30.

Thereupon, transport chain 24 transports the extracted container 40 to a processing location. Sub-chains 50, 51, 52 keep the container upright throughout the path of transport chain 24, because third sub-chain 52 moves ahead or backward of first and second sub-chain 50, 51 so as to keep gripper 55 at a fixed orientation. Processing unit 60 records in memory 62 that the relevant attachment point no longer contains container 40. A cover plate or plates may be added around the portion of the band that is bent by the bending element, at a part of that portion where the gripper does not access the band. This reduces the risk that containers drop out of the band when it is bent, but of course these plates may be omitted if the band provides for a sufficient holding force to minimize this risk.

Preferably, deattachment is performed in this way at a plurality of the units 20, 22 in parallel, transferring a plurality of containers to a series of successive positions along transport chain 24. Thus, containers may be transferred to the transport chain 24 at a high throughput rate.

After liquid from the containers on transport chain 24 has been used, transport chain 24 transports the containers back to the bands 30 in the units 20, 22. Also “new” containers, which were not stored in the storage device, or were stored in another storage device may be transported to bands 30 via transport chain 24.

The procedure for (re-)attachment of these containers is similar to the procedure for de-attachment. When containers have just been removed from bands 30 at the positions where transport chain 24 has access to bands 30, grippers 55 insert the containers that must be reattached into band 30. Fingers 56 are moved apart. Gripper 55 is then pulled back, leaving the container at the attachment point in band 30. As an alternative to moving fingers 56 towards each other to pull container 40 from band 30 and moving fingers 56 back apart to allow band 30 to retain container 30, a blocking mechanism such as a electrically actuated latch may be used to selectively block and not block movement of container 40 when gripper 55 moves away from band 30. In this case resilient fingers 56 release container 40 when the gripper is moved away from band 30 when the blocking mechanism blocks movement of the container.

The control system receives a signal identifying the containers on transport chain 24. Processing unit 60 records the attachment of the specified containers at the attachment points where the containers have been attached.

Although the operation of the storage device has been described in terms of a specific implementation, it should be realized that many variations are possible without deviating from the invention. For example, although it is preferred that containers are deattached from all units 20, 22 in parallel, and that other inserted back at all of the attachement positions from which these containers have been deattached, it is of course possible to attach and deattach only in selected units 20, 22. In fact, it is also possible to attach and deattach containers in parallel, so that a container is attached from one unit 20, 22 from transport chain 24 at the same time when a container is de-attached from another unit 20, 22 to transport chain 24.

Also, in combination with such selective de-attachement and attachment, or independently, each band 30 may be spooled between successive transfers, so as to move an unoccupied attachment point to the transport chain 24 before attaching a container. In this case, processing unit 60 consults memory 62 to identify an unoccupied attachment point and controls spooling of the band 30 so as to move the unoccupied attachment point to the transfer chain.

Furthermore, although a single transport chain has been shown, more than one transport chain may be used, or the transport chain may follow a path that leads it transverse to the bands more than once. This provides for attachment and/or de-attachment of containers at more than one position in the exposed portion of band 30 in each unit 20, 22, each position being accessible to a respective one of the transport chains, or to a respective part of the transport chain 24. For example, one position may be used for attachment exclusively and another for de-attachment.

In another example, a fixed attachment point may be reserved for each container. Thus, no update to the information in memory 62 is needed when a container is de-attached or re-attached. However, in this case a container cannot be re-attached at any attachment point, such as the attachment point from which a container has most recently be de-attached. In this case, bands 30 need to be spooled to bring the attachment point for the container in proximity with the transport chain 24.

Of course, instead using a blocker 39, fingers 56 of gripper 55 may be actuated to grip or release the containers in the band when the containers are deattached or attached respectively.

It will be realized that the use of a band as shown in FIG. 4 is highly advantageous because it does not require a complex manufacturing process for manufacturing the band and because the band contains no moving parts, which is especially advantageous in a cooled storage device. In addition, only movements perpendicular to the surface of the band are needed to attach and de-attach containers. This makes it possible to stack units 20, 22 closely together.

The band may be made of any sufficiently strong material, such as for example stainless steel, or it may be a combination of wires that run along the length of the band and holders attached to the wires. The construction with cut out portions and springs that are integral with the band, so that the containers are clamped into the cut out portions facilitates on one hand an effective and easily manufactured solution to hold the containers securely in band 30 and on the other hand it facilitates a simple way of reducing the holding force on one side of band 30 by bending the band sufficiently to make springs 42 recede away from the container 40. Of course, instead of integrally formed springs 42 attached springs, for example springs that have been glued or welded to band 30 may be used.

However, in general without deviating from the invention any mechanism may be used to attach en de-attach containers to band 30. For example, band 30 may be provided with cup shaped holders for the containers, into which the containers can be inserted and removed by means of a movement of the container transverse to the longitudinal direction of band 30, the movement being provided by transport chain 24, for example. Containers 40 may be provided with clips to clip the containers onto band 30. In this case band 30 need not be structured in any way, save perhaps for some guiding structures to ensure that the containers are kept at the position where they are clipped onto band 30. In these examples there is no need to bend band 30 in a special way to attach or deattach containers: bending element 26 and covering plates 28 need not be provided, although of course instead some elements may be provided to ensure that the exposed portion of band 30 passes through a predetermined location where the containers are transferred between transfer chain 24 and band 30.

Although processing unit 60 and memory 62 have been described as separate units with an interface for receiving signals that select liquid containers, it will be understood that processing unit 60 and/or memory 62 may also be used for controlling other functions outside the storage device. In this case, the control unit may also generate the signal that selects the liquid containers itself, for example in response to a command to perform an experiment, if a required set of containers can be determined by the processing unit 60 by processing the command. In this case the interface 64 may be an internal (e.g. software-) interface inside processing unit 60: no external signals are needed. But of course, the control unit may also be dedicated to the storage device, receiving selections of containers from outside.

In summary it can be seen that the storage device provides for compact storage of a large number of liquid containers and high speed access for inserting and removing containers. This realized by using a band to which the containers are attached, and by winding opposite ends of the band around two rotatable axes. Thus, the band can be spooled at high speed to expose a part of the band with a desired container to take out the container. In a further embodiment compact storage for even more containers is realized by stacking a number of units of this type, each with its own band and two rotatable axes. Preferably, a transport chain runs along the stacking direction, along the successive exposed parts of the bands in the stack. Thus, the containers can be transferred in parallel to and from the transport chain form and to a plurality of bands. Preferably, the containers are attached and deattached by movement transverse to the band, in a plane perdendicular to the rotatable axes. This allows the bands to be stacked closely together. The containers may be attached by means of a spring mechanism, preferably so that the holding force of the springs can be reduced by bending the band. But other types of attachment may be used as well.

Sampling

Conventional sampling techniques include using a pipette to take up a sample of liquid from a bulk supply of liquid such as a liquid container. (The word “bulk” is of course only relative: it merely indicates a supply from which a plurality of samples can be taken). The sample is forced out of the pipette on to a sample holder for example by applying pressure to the sample though the inner channel of the pipette. This technique may be used in the apparatus described to transfer liquid samples from the containers to a band with cavities that transports the samples though various processing stages. When a vast number of samples has to be processed it is desirable that each sample contains a very small amount of liquid. At the same time these amounts have to be reasonably reproducible, especially when multiple samples of different liquids have to be mixed in accurate proportions. This becomes more and more difficult to ensure as the desired amount of liquid decreases. It has been found that this is mainly due to the transfer of the liquid sample from the pipette to the sample holder, and not so much to the transfer from the bulk supply to the pipette. As the amount of liquid in the sample decreases the relative effect of adhesion of the liquid to the pipette increases, making it more and more difficult to ensure that a reproducible amount of the liquid in the pipette is transferred to the sample holder.

It is an object of the invention to provide for a way of extracting samples that permits the production of a reproducible amount of liquids in each sample, even for very small samples.

This object is realized by picking up a sample of liquid with a pipette, freezing at least the outside of the sample in the pipette, thawing the boundary layer between the frozen part of the sample and the pipette and then forcing the sample out of the pipette into a sample holder. Thus it is ensured that all of the sample, except possibly for a small and well determined amount of liquid in the boundary layer is forced into the sample holder. This technique is not limited to the apparatus shown in the other figures and described in the other sections.

FIG. 7 shows part of a sample forming machine. The machine contains a tube 70, which functions as a pipette, a control unit 72, a cooling unit 74, a heater 76, a bulk liquid container 77, a sample holder 78 and a forcing unit 79. Heater 76 comprises resistive wiring around the tube. Cooling unit 74 is coupled to tube 70. Control unit 72 controls is arranged to control electric current through heater 76, and to control the couplings between cooling unit 74 and tube 70. Control unit 72 also control a movement mechanism (not shown) for moving tube into bulk liquid container 77 and from there to sample holder 78.

In operation control unit 72 causes the movement mechanism to move an end of tube 70 into the liquid in bulk liquid container 77. Tube 70 is then used to take up a sample of liquid. This may be done using any known technique, for example by reducing the pressure at another end of tube 70 opposite the end of the tube than has been inserted in the liquid, or by closing off that other end at that time. Control unit 72 then causes the movement mechanism to move tube 70 out of the liquid. Subsequently, control unit 72 activates the coupling between cooling unit 74 and tube 70. This causes tube 70 to cool down to a temperature where the liquid in the sample in tube 70 freezes. For the invention it does not matter if a core of the sample remains unfrozen.

Subsequently, control unit 72 decoupled cooling unit 74 from tube 70 and activates heater 76 for a predetermine time interval, chosen so that it last sufficiently long to thaw a boundary layer between tube 70 and the sample, but not long enough to thaw the bulk of the sample. Also, control unit 72 causes the movement mechanism to move tube 70 to sample holder 78. After reheating to thaw the boundary layer the still frozen bulk of the sample is forced from tube 70 into sample holder 78, for example by applying gas pressure in tube 70 behind the frozen sample. Movement of the tube may occur before, after or simultaneously with cooling and reheating, but preferably at least reheating occurs immediately before the sample is force from tube 70, so that heat diffuses as little as possible into the frozen bulk of the sample. In this way very small samples may be produced. As a example, a tube 70 with an insider diameter of 100 micrometer may be used, which is cooled to −10 degrees Celsius and then reheated to 20 degrees Celsius. Of course any other suitable temperature may be used. Also the inner diameter of tube 70 and the length of tube that is submerged into liquid in liquid container 77, and/or the reduction of pressure in tube 70 may be chosen more or less arbitrarily as needed to realize a desired amount of liquid in the sample. Preferably, the inside space in tube 70 is cylindrical in shape with a circular cross-section, but of course other shapes and cross sections may be used, provided the inner shape of the end of tube 70 does not obstruct the frozen sample when it is forced out into sample holder 78.

Cooling may be realized in various ways. For example cooling unit 74 may in fact be a bath of cold liquid, such as liquid nitrogen and coupling with the bath may be realized by moving at least the end of tube 70 into the bath. In another example a bath of cold liquid, or any other cooled element, is coupled to a gripper (not shown), so that the gripper cools down and control unit 72 causes the gripper to grip tube 70 at or near the end that contains the liquid in order to cool down the liquid.

Processing of Samples

FIG. 8 shows an apparatus for processing samples schematically in side view. The apparatus contains a loading station 18, 14, 15, a plurality of processing stations 81, 82, an extraction station 86 and a flexible band 84 with cavities for liquid samples. For the loading station reference is made to FIG. 1: it contains spool 18, sample forming apparatus 14, and sealing unit 15. Processing apparatus 16 of FIG. 1 correspond to processing stations 81, 82. A continuous stretch of band 84 runs from a spool 18 through the plurality of processing stations 81, 82 onto extraction station 86. As shown, band 84 passes several times through the same station 82; in between band 84 passes through other ones of the stations 81.

The path of band 84 is shown to pass into each processing station 81, 82, to fold around over wheels 91 in the processing station 81, 82 and to pass out of the processing station 81, 82 on its way to the next station. Band 84 may be pulled forwards along the path at various points in the apparatus of FIG. 8, preferably band 84 is pulled forward at least in the extraction station, but any number of wheels driven by motors (not shown) may be used to pull band 84 along the path an through the processing stations 81, 82.

In operation liquid samples are loaded into band 84 at loading station 80. Loading station is provided with spool 18 that contains a length of band with cavities that are empty of samples. Band 84 is spooled from spool 18 to locations where samples forming apparatus 14 insert samples in band 84. Preferably, sample forming apparatus contains a plurality of sample forming units that operate in parallel, inserting possibly different samples, possibly from different sources, into a plurality of cavities in parallel. In an embodiment, moreover, sample forming apparatus contains a plurality of stages, successive stages inserting samples of different liquids into the same cavities. From sample forming apparatus 14 band 84 moves into sealing unit 15 and from there in and out of successive processing stations 81, 82.

Each processing station 81, 82 applies a processing step, such an adjustment of the temperature to a predetermined bath temperature, to the samples in band 84. The duration of each processing step is determined by the speed of movement of band 84 and the length of the path of the band in the processing station 81, 82. This length of the path of the band in the processing station may be adjusted to any desired length by adjustment of the position of wheels 91 in the processing stations 81, 82, relative to the entrance and exit of processing station 81, 82. For processing steps that have an exceptionally long duration further wheels (not shown) may be provided in processing stations 81, 82 so as to provide a folded longer path through selected ones of the processing stations 81, 82.

After the processing steps band 84 passes to extraction station 86 sample fluid is taken from band 84 by injecting a sample extraction needle into the band at the position of a sample, and extracting the sample from the band 84. After such extraction band 84 may be shredded. As an alternative, the band may be cut to pieces that contain one or more of the cavities. The pieces are used for further individual processing of samples from band 84, the individual processing being selected for each sample individually.

FIG. 9 shows part of an embodiment of extraction station 86, wherein extraction station optionally contains a centrifuge wheel 140 and expansion sections 142, 144 for band 84 to centrifuge the samples against the a wall of cavities in which the samples are present (preferably the bottom) prior to extraction of the samples. This ensures that the sample liquid is present at a predictable position when the samples are extracted. In this embodiment the expansion sections each contain a wheel 146a,b around which the path of band 84 is folded back. Band 84 is first lead through a first expansion section 142 and subsequently around centrifuge wheel 140, after that band 84 is lead through another expansion section 144. The axes of the wheels 146a,b in the expansion sections 142, 144 are moveable over a translation path 148a,b to vary the length of band 84 in the expansion units 142, 144. The axes are spring loaded to pull the wheels 146a,b to provide a maximum path length.

In operation, each time when a section of band 84 has been wound around centrifuge wheel 140, centrifuge wheel 140 is spinned around to centrifuge the samples against the bottom of cavities 90. The spinning speed is much higher than the transport speed of band 84. The speed difference is compensated because the wheels 146a,b in the expansion units 142, 146 are pulled to shorten the path of band 84 before the centrifuge wheel 140 in front of the spinning centrifuge wheel 140 and to lengthen the path behind the spinning centrifuge wheel 140.

FIG. 10 shows an embodiment of band 84 in mode detail. Cavities 90 and caps 94 are shown. The caps are cut out of band 84 in sealing unit 15 before being inserted into cavities 90 after liquid samples have been inserted into cavities 90. Weakening holes 96 have been cut into band 84. The weakening holes serve to ensure that band 84, when bent, deforms mainly at locations between cavities and not at the locations of cavities 90.

FIG. 11 schematically shows a side view of band 84 in cross-section through a cavity 90 and a cap 94. Band 84 contains a succession of cavities 90 and caps 94 along the length of band 84 (transverse to the cross-section shown in FIG. 11). Band 84 is shown to have a lowered portion 120 around cap 94, which is lower than the surface 121 of band 84. A cutting location 122 has been indicated in lowered portion.

FIG. 12 shows a side view of band 84 in cross-section through a cavity 90, with cap 94 placed on top of cavity 90.

Cavity 90 and cap 94 have a conical shape. The diameter of the conical parts of cavity 90 and cap 94 increases from bottom to top, a bottom conical part of cavity 90 being congruent to an upper conical part 111 of cap 94, so that upper conical part 111 of cap 94 fits into the bottom conical part of cavity 90, leaving a space 110 for the sample liquid when cap 94 has been inserted into cavity 90. Cap 94 has a narrowed bottom conical part 112, which does not touch the lower conical part of cavity 90 (or at least does not touch this conical part over its entire circumference) when cap 94 has been inserted into cavity 90.

Similarly cavity 90 has a widened top conical part 113, which does not touch the upper conical part of cap 94 (or at least does not touch this conical part over its entire circumference) when cap 94 has been inserted into cavity 90. Cap has a flange 116 and cavity has a flange 118, the flanges touching when cap 94 has been inserted into cavity 90.

The invention is not limited to bands 84 with a single row of cavities 90. As an alternative a band with a row of cavities abreast band 84 may be used. Such a band 84 permits a higher throughput of samples at the same speed. Also, successive sets of rows of cavities may be cut out of band 84 to form trays with a matrix of cavities after processing, to facilititate further processing.

In operation, the samples are inserted into cavities 90, typically a plurality of samples from different liquids is inserted and mixed in each cavity 90, for example a sample of diluted DNA, a sample of diluted marker liquid and further a sample of dilution liquid. During sealing cap 94 is cut out from band 84 at cutting location 122 (leaving flange 116 attached to cap 94) and moved into cavity 90 with the sample, so as to close off cavity 90.

First bottom conical part 112 enters cavity 90 and subsequently middle conical part 111 enters cavity. The size of cap 94 has been adapted to the amount of sample liquid that is inserted into cavity 90. Bottom conical part 112 pushes the sample liquid upward, so that the liquid level rises at least to the level where top conical part 111 will touch the conical part of cavity 90 when cap 94 has been inserted. Any excess liquid is pushed into a space left between top conical part 113 and cap 94. Thus it is ensured that no air is left with the liquid that has been enclosed between the bottom of cavity 90 and cap 94. After insertion and closing of the cavities 90 band 84 moves to processing stations 81, 82 for processing of the samples.

In addition sealing unit 15, preferably contains a heatable ring, which is pushed against flanges 116 118 at least where they are in mutual contact, so as to create a connection between the flanges, to improve the tightness of the seal between cap 94 and cavity 90 and to prevent cross-contamination of the cavities 90.

The depth of lowered portion 120 relative to surface 121 is selected so that the bottom of cavity 90 and cap 94 are at the same distance to surface 121 of the band, cap 94 being smaller than cavity 90 to allow room for the sample when cap 94 is inserted in cavity 90. As a result of the fact that the bottom of cavity 90 and cap 94 are at the same distance to the surface of band 84, band 84 can be provided on spool 18 without skewing.

It should be appreciated that the invention is not limited to the particular embodiment shown in the figures. For example, the extra narrowing and widening of the conical part of cap 94 may be omitted if it is not necessary to exclude air. The narrowed aspect of bottom conical part 112 facilitates the flow of liquid to expunge the air when the cap is inserted, but if the liquid flows sufficiently rapidly this narrowing is not necessary. Instead of using a widened top conical part 113 in cavity 90 a narrowed top conical part may be used in cap 94.

Instead of using caps 94 that are cut out of band 84, one may use caps 94 from a different source. However, when caps 94 and cavities 90 are included in the same band 84, there is no need to provide and synchronize separate transport chains for caps 94 and cavities 90. Also, instead of using caps 94 and/or cavities 90 that have been formed from band 84, separate caps 94 and/or cavities 90 may be used that have been inserted into band 84. A band with such caps 94 and cavities 90 can be supplied on a spool to be used in the apparatus.

Band 84 is preferably manufactured by heating to form caps 94 and cavities, and cutting of weakening holes 96. This provides for the manufacture of bands with vast numbers of cavities at low cost. Polycarbonate or propylene may be used as material for band 84. It will be appreciated that the invention is not limited to this material and any method of manufacturing the band, other methods such as heat forming may also be used and other materials such as aluminium foil may be used. It will be also appreciated that closure of the cavities need not necessarily be realized with caps that are integral with band 84. For example, a foil such as plastic foil might be sealed to band 84 instead to seal of cavities 90.

1. A liquid sample processing apparatus, comprising
a plurality of processing stations, each for applying at least one processing step to liquid samples;
a flexible band that supports a series of cavities for the liquid samples along a longitudinal direction of the band,
a band supply unit for feeding band into the processing apparatus
transport guides for transporting the flexible band through the plurality of processing stations, so that the band extends continuously through at least two of the processing stations during processing
an output station for disposing of the band when it has passed through the processing stations.

2. A liquid sample processing apparatus according to claim 1, wherein the cavities are integrally formed parts of the band.

3. A liquid sample processing apparatus according to claim 1, comprising a filling station and a sealing unit, the band passing from the supply unit via the filling station and the sealing unit to the processing stations, the sealing unit being arranged to insert respective caps each into a respective one of the cavities.

4. A liquid sample processing apparatus according to claim 3, wherein the caps and the cavities each have a conical portion, first parts of the conical portions of the cap and the cavity fitting against each other when the respective cap has been inserted in the respective one of the cavities, there being a space between second parts of the conical portions of the cap and the cavity, beyond the first parts, as seen from a bottom of the cavity, when the respective cap has been inserted in the respective one of the cavities.

5. A liquid sample processing apparatus according to claim 4, wherein the conical portion of the caps have a third part closer to bottom of the cavity than the first part, the third part being narrower than a surrounding part of the conical portion of the cavity.

6. A liquid sample processing apparatus according to claim 3, the cap and the cavity each having a flange, the flanges resting on each other when the cap has been inserted into the cavity, the sealing unit having joining means for joining the flanges.

7. A liquid sample processing apparatus according to claim 1, wherein the caps and cavities are integrally formed parts of the band, the sealing unit being arranged to cut the caps at least partially from the band before inserting the caps into the cavities.

8. A liquid sample processing apparatus according to claim 1, wherein the a track of the flexible band is folded at an adjustable position in at least one of the stations, so as to provide for an adjustable duration of the processing step applied in that at least one of the processing stations, relative to a duration of the processing step applied in a further one of the plurality of processing stations.

9. A liquid sample processing apparatus according to claim 1, wherein the flexible band is wound so that the band passes at least twice through a first one of the processing stations, before and after passage through a second one of the processing stations respectively.

10. A liquid sample processing apparatus according to claim 1, comprising a cutting device for cutting the flexible band into successive fragments that contain one or more cavities after applying the processing steps.

11. A liquid sample processing apparatus according to claim 1, comprising a centrifuge unit, with a centrifuge wheel, a wheel drive and a track length adjustment unit, the track of the band running around the centrifuge wheel and through the track length adjustment units, the wheel drive being arranged to speed up a spinning speed of the centrifuge wheel intermittently relative to a transport speed of the band through the liquid sample processing apparatus, the track length adjustment units varying a length of the track to compensate variations in the difference between the spinning speed and the transport speed.

12. A method of processing liquid samples, the method comprising
feeding a flexible band that contains a series of cavities arranged along a longitudinal direction of the flexible band
inserting the liquid samples into the cavities;
guiding the band through a succession of processing stations, so that the band extends through at least two of the stations when the processing steps of the at least two of the stations are applied
disposing of the band subsequent to processing.

13. A method according to claim 12, comprising sealing each cavity with a cap inserted into the cavity so as to close off the liquid sample.

14. A method according to claim 13, comprising pushing out air and any excess sample liquid from a closed off part of the cavity with the cap prior to sealing.

15. A method according to claim 14, comprising trapping the excess sample liquid in a further part of the cavity.

16. A method according to claim 13, comprising first sealing the cavity with a contact surface at which the cap fits in the cavity and second sealing, joining surroundings of cap and cavity to each other.

18. A method according to claim 12, wherein a duration of at least one of the processing steps relative to a remainder of the processing steps is adjusted by adjusting a location where a track of the flexible band is folded.

19. A method according to claim 12, the method comprising guiding the band repeatedly through a first one of the stations, before and after guiding the band through a second one of the processing stations.

20. A method of processing according to claim 12, the method comprising subjecting part of the band to a rotational movement, subjecting the liquid in the cavities in said part of the band to a centrifugal force, followed by extraction of liquid from the cavities in said part of the band.

21. A band for transporting liquid samples, comprising
a plurality of cavities in the band, arranged at least in a longitudinal direction along the band;
caps in the band, each adjacent to a respective one of the cavities.

22. A band according to claim 21, wherein caps and cavities are integral parts of the band.

23. A band according to claim 21, wherein each cap and cavity have a conically shaped surface part, formed so that the conically shaped surface part of the cap can be fitted tightly to the conically shaped surface part of the cavity.

24. A band according to claim 23, wherein each cap and cavity have a further surface part beyond the conically shaped surface part, as seen from a bottom of the cavity, the further surface part being shaped to leave a space remaining between the further surface parts when the conically shaped surface parts of cap and cavity are fitted together.

25. A band according to claim 21, wherein the cap and the cavity each comprise a flange, the flanges having been heat sealed to each other.

26. A band according to claim 21, comprising a band surface and indentations with a cutting surface substantially parallel to the band surface, set off from the band surface, the cavities extending from the band surface, each cavity extending from respective one of the cutting surfaces, so that a plane through bottom edges of the caps and cavities extends substantially in parallel with the band surface.

27. A method of preparing a plurality of liquid samples for collective processing, the method comprising
integrally forming cavities and corresponding caps in a band in a row in a longitudinal direction along the band;
inserting each liquid sample in a respective one of the cavities;
moving each cap to a closing positions with respect to the corresponding cavity when that the sample has been inserted in that cavity.

28. A method according to claim 27, comprising pushing out all air a part of the cavity that is sealed off by the cap prior to sealing.

29. A method according to claim 28, comprising trapping any excess liquid pushed out with the air in a further part of the cavity.

30. A method according to claim 29, comprising further sealing the cavity to seal off the trapped excess liquid.

31. A method according to claim 27, comprising head sealing the cap onto the cavity when the caps has been moved into closing position.

32. A method according to claim 27 comprising heat forming to form the cavities and the caps in the band.

33. A method according to claim 27 comprising making a cut surrounding a part of the cap, so that the cap becomes moveable relative to the band, for movement onto the corresponding cavity.

34. A method of preparing samples of a liquid, the method comprising
providing a container with liquid material;
taking up a sample of the liquid material into a tube;
freezing at least a surface of the sample in the tube;
heating the sample so that a boundary layer between the sample and the tube liquefies, a remainder of the sample remaining frozen, and subsequently
forcing the sample out of the tube into a sample holder.

35. A liquid sample preparation unit, comprising
a tube;
a cooling unit, coupled to the tube for freezing at least a surface of a sample of liquid in the tube;
a heating unit coupled to the tube, for heating at least a boundary layer between the sample and the tube;
sample ejection means arranged to eject the sample from the tube after a start of heating the tube, when the boundary layer has liquefied, but before the sample as a whole has liquefied.

36. A storage and transport unit for liquid containers, comprising
a plurality of liquid containers;
a first and a second rotatable axis;
a band that is windable from the first rotable axis to the second rotable axis and vice versa, the band containing attachment points, each arranged for reversible attachment and detachment of at least one of the liquid containers;
a transport unit arranged to detach, transport and reattach the liquid containers on the band.

37. A storage and transport unit according to claim 36 wherein the attachment points are arranged to allow the containers to be attached and detached with a movement in a plane perpendicular to the first and second rotatable axis.

38. A storage and transport unit according to claim 36, wherein the each attachment point contains a spring mechanism for holding a respective one of the containers.

39. A storage and transport unit according to claim 38, wherein the spring mechanism is constructed so that a holding force of the spring mechanism for holding the container is reduced when the band is bent, the transport unit containing a bending element, for locally increasing a radius of the band at a location for attachment and/or de-attachement of the containers.

40. A storage and transport unit according to claim 36, comprising a control unit with a memory for registering identifications of the attachment points positions, the control unit being arranged to control deattachment of a particular one of the liquid containers by
recovering the identification of the position of the attachment point where the particular one of the liquid containers is attached to the band;
controlling spooling of the first and second rotable axes so that the band is wound to move said position a deattachment location relative to the transport unit, where said position is not within a spooled part of the band;
controlling takeover from the band to the transport unit when said position is at said location.

41. A storage and transport unit according to claim 40, the control unit being arranged to control reattachment of the particular one of the liquid containers by
selecting an unoccupied attachment point on the band;
controlling spooling of the first and second rotable axes so that, if needed, the band is wound to move the position of the selected attachment point to an attachment location relative to the transport unit, where said position is not within the spooled part of the band;
controlling reattachment of the particular one of the containers to the band at the selected unoccupied attachment point
updating a content of said memory to register an identifications that the particular one of the liquid containers is attached at the selected unoccupied attachment points.

42. A storage and transport unit comprising a stack of subunits, each subunit containing
a first and a second rotable axis;
a band that is windable from the first rotable axis to the second rotable axis and vice versa, the band containing attachment points, each arranged for reversible attachment and detachment of at least one of the liquid containers;
the transport unit running transverse to the bands of the subunits in the stack, the transport unit being arranged to deattach and reattach the liquid containers from the subunits in the stack in parallel.

43. A storage and transport unit according to claim 42 wherein the attachment points in each subunit are arranged to allow the containers to be attached and detached with a movement in a plane perpendicular to the first and second rotatable axis.

44. A storage and transport unit according to claim 42 wherein the transport unit comprises a transport chain, with holders for the liquid containers, the holders having a hanging construction so that the liquid containers hang vertically from the transport chain, irrespective of an orientation of the transport chain, the transport chain running through a corner from the to a liquid transfer point.
